(19) United States
(12) Patent Application Publication
(10) Pub. No.: US 2002/0020311 A1
(43) Pub. Date: Feb. 21, 2002

(54) Method of treating print screens

(76) Inventors: Philip Lynn Dark, High Point, NC (US); Gary Wayne Murray SR., Kernersville, NC (US)

Correspondence Address: CIBA SPECIALTY CHEMICALS CORPORATION, PATENT DEPARTMENT, 540 WHITE PLAINS RD, P O BOX 2005, TARRYTOWN, NY, 10591-9005, US

(21) Appl. No.: 09/836,114

(22) Filed: Apr. 17, 2001

Related U.S. Application Data
(60) Provisional application No. 60/198,527, filed on Apr. 19, 2000.
(60) Provisional application No. 60/245,524, filed on Nov. 3, 2000.

(51) Int. Cl. B41N 1/14

(52) U.S. Cl. 101/128.21

(57) ABSTRACT

A method of treating a print screen in order to retard blockage and to make the screen easier to clean comprises treating the print screen with a compound containing a fluorinated radical and a polar radical.

The present invention relates to a method of treating a print screen in order to retard blockage and to make the screen easier to clean. More particularly it relates to a method of treating a print screen with a compound containing a fluorinated radical and a polar radical in order to retard blockage and to make the screen easier to clean.

### BACKGROUND OF THE INVENTION

Designs and images are commonly printed onto textile substrates by forcing a printing paste containing a colorant through special print screens. These screens are normally either made of nickel or of a textile material such as polyester and have small perforations in selected areas that permit the printing paste to pass through.

During the process of printing textile substrates using print screens there is a buildup of the various printing auxiliary products and colorants, which tend to adhere to imperfections on the surface of the screen and to block the small openings in the screens. Since this buildup degrades the quality of the printed product, the printing process must be periodically interrupted so that the screens can be replaced or deaned and returned to service. Additionally any interruption in the printing process or delay in cleaning the screens which allows the printing paste to dry on the screens makes subsequent cleaning much more difficult.

The problems associated with printing screen obstruction have a significant effect on both the cost and throughput of printing textile substrates using print screens. Hence there has been a long felt need for a method of treating a print screen in order to retard blockage and to make the screen easier to clean.

U.S. Pat. No. 3,083,224 discloses certain polyfluoroalkyl phosphates which are useful in imparting oil repellency to paper and textile materials.

U.S. Pat. No. 3,910,187 discloses that fluorine-containing compounds containing a fluorinated radical and a polar radical, which includes polyfluoroalkyl phosphates, are useful in treating dry planographic printing plates. These solid plates, which are usually made of aluminum, are used for lithographic printing on paper. They have a surface having a printing portion which is receptive to printing ink and a non-printing portion which repels printing ink. The fluorine-containing compound containing a fluorinated radical and a polar radical is used to treat only the non-printing portion of the metal plate.

Surprisingly it has now been found that treating a print screen with a fluorine-containing compound containing a fluorinated radical and a polar inorganic or organic radical retards blockage of the screen and makes the screen easier to clean for reuse.

### DETAILED DISCLOSURE OF THE INVENTION

The present invention relates to a method of treating a print screen in order to retard blockage and to make the screen easier to clean, which comprises treating the print screen with a compound containing a fluorinated radical and a polar inorganic or organic radical.

Preferably the screen is treated with a compound of the formula

((R_{F})ₓ-W)ₙZ (1)

wherein

R_{F} is a straight or branched-chain perfluoroalkyl group containing 4 to 20 carbon atoms,

W is an aliphatic or cycloaliphatic radical with 1 to 15 carbon atoms,

x is 1-3,

n is 1 or 2, depending on the valence of Z, and

Z is a polar inorganic or organic radical.

Preferably x is 1 to 2, especially 1.

Preferably the polar radical is acidic.

Preferred acidic polar radicals include —COOH, —SO₃H, —PO₂H, —P(OH)₂ and —OP(O)(OH)₂ wherein n is 1 and O₂P(O)OH wherein n is 2, and salts thereof. Especially preferred acidic polar radicals are —OP(O)(OH)₂ when n is 1 and O₂P(O)OH when n is 2, or a mixture thereof. Preferably this acidic radical or mixture of acidic radicals is partially or fully in the form of a salt, for example an ammonium salt, or an ammonium salt that is mono-, di-, tri- or tetra-substituted by C₁C₄alkyl, C₁-C₄-hydroxyalkyl or a mixture thereof.

When the salt is ammonium that is mono-, di-, tri- or tetra-substituted by C₁-C₄hydroxyalkyl, it is preferably diethanol-, disopropanol- or triethanolammonium, with diethanolammonium being particularly preferred.

It is particularly preferred to treat the print screen with a compound of the formula (1),

wherein

R_{F} is a straight or branched-chain perfluoroalkyl group containing 6 to 16 carbon atoms,

W is an aliphatic or cycloaliphatic radical with 1 to 12 carbon atoms,

x is 1-2,

n is 1 or 2, depending on the valence of Z, and

Z is a mixture of —OP(O)(OH)₂ and O₂P(O)OH radicals or salts thereof.

Preferably this compound is partially or fully in the form of the diethanolammonium salts of the —OP(O)(OH)₂ and O₂P(O)OH radicals.

Most preferably R_{F} is a straight chain perfluoroalkyl group containing 6 to 16 carbon atoms, x is 1 and W is —CH₂—CH₂—.

Fluorine-containing compounds of the formula (1) are known per se and can be prepared by known methods.

Particularly useful compounds in the present invention include ZONYL 9027 from DuPont and LODYNE P-206 and DPC-8905, both from Ciba Specialty Chemicals Corp.

DPC-8905 is a dilute aqueous solution comprising about 3.5% by weight of a mixture of compounds of the formula (1), wherein R_{F} is a mixture of straight chain perfluoroalkyl groups containing 6 to 16 carbon atoms, W is —CH₂—CH₂—, x is 1, n is 1 or 2, depending on the valence of Z, and Z is a mixture of —OP(O)(OH)₂ and O₂P(O)OH radicals which are in the form of a mixture of their diethanolammonium salts. It is obtainable from TELOMER B. an oligomeric perfluoroalkylethyl iodide product of DuPont, by methods known per se.

DP-C8905's use is preferred in the present invention as it is highly effective and is at a suitable concentration to be used as is for screen treatment Other commercially available fluorine-containing according to the invention are generally more highly concentrated and compounds should be diluted with water and/or a water-miscible organic solvent to a concentration of 0.1-35% by weight of the fluorine-containing compound prior to use. Fluorine-containing compounds according to the invention are preferably diluted to a concentration of 1-12%, most preferably 2-6% by weight of the fluorine-containing compound prior to use.

Thus the method of the present invention comprises treating a print screen with a composition comprising 0.1-35% by weight, more preferably 1-12% by weight and most preferably 2-6% by weight of a compound containing a fluorinated radical and a polar inorganic or organic radical. Preferably said compound is a compound of the formula (1) as defined above. More preferably the method of the present invention comprises treating a print screen with a composition comprising 2-6% by weight of a compound of the formula (1)

wherein

R_{F} is a straight or branched-chain perfluoroalkyl group containing 6 to 16 carbon atoms,

W is an aliphatic or cycloaliphatic radical with 1 to 12 carbon atoms,

x is 1 or 2

n is 1 or 2, depending on the valence of Z, and

Z is a mixture of —OP(O)(OH)₂ and O₂P(O)OH radicals which are partially or fully in the form of their diethanolammonium salts.

The method of the present invention can be applied to all kind of print screens and engraved print rollers, e.g. those made of metal and/or synthetic organic material. Examples of useful metals are nickel, chromium or copper as well as alloys containing two or more metals, especially two or more of the above mentioned metals.

The synthetic organic materials include polyester, especially PET (polyethylene terephthalate).

The print screens and print rollers can be lacquered or non-lacquered and can be used for printing of different materials, especially textile material or paper, including paper for transfer-printing, using the customary printing pastes. These printing pastes can contain e.g. textile or paper dyes and/or fluorescent whitening agents, e. g. reactive, disperse, vat, direct, acid, basic, cationic or transfer dyes or pigments.

The treatment is conveniently carried out by contacting the print screen with the treatment composition by any conventional method, for example by dipping, spraying, pouring or brushing, and then allowing the treatment composition to drain and dry. Typical pickup of the treatment composition is about 10% by weight, based on the weight of the screen.

Preferably the treated screen is subjected to a heat treatment, for example in an oven. Without wishing to be bound by any theory, it is believed that the heat treatment not only drives off residual water and organic solvent, but also facilitates breakdown of the ammonium salts, thereby generating acidic radicals which adhere more effectively to the surface of the screens.

Preferred heat treatment temperatures are from about 80-230° C., in particular from 130-210° C. Suitable heat treatment times will vary inversely with the temperature and can be determined by routine experimentation. For example, satisfactory results with a metal screen are obtained with a 10 minute heat treatment at about 175° C. or a 5 minute heat treatment at about 195° C.

The print screens and print rollers which have been treated with a compound containing a fluorinated radical and a polar inorganic or organic radical are further subjects of the present invention.

The effectiveness of the screen treatments was determined in experiments wherein a print screen was vertically dipped into a treatment solution so that only about half of the screen was exposed to the treatment solution. The untreated half thus served as a control. After allowing the treatment composition to drain and dry the entire screen was then subjected to a 10 minute heat treatment at about 175° C. as described above.

Printing pastes customary in textile printing comprise, in addition to one or more pigments or dyes, customary dyeing assistants, for example advantageously thickeners of natural or synthetic origin, for example commercially available alginate thickeners, starch ethers or locust bean flour, in particular sodium alginate, by itself or as a mixture with modified cellulose, in particular with preferably 20 to 25 percent by weight of carboxymethylcellulose.

Synthetic thickeners are often employed in printing pastes, for example those based on poly(meth)acrylic acids, poly(meth)acrylamides and co- and terpolymers thereof. Printing pastes can also comprise acid donors, such as butyrolactone or sodium hydrogen phosphate, binders, crosslinkers, preservatives, sequestering agents, emulsifiers, water-insoluble solvents, oxidizing agents or deaerating agents.

To evaluate the effectiveness of the inventive method a standard blue print paste containing 10% Blue BGR pigment and 15% of a conventional acrylic binder was printed across the treated and untreated areas of the screen on a laboratory print table using a standard 8 mm print bar. With a screen that is treated with DPC-8905 from Ciba Specialty Chemicals Corporation as described above, it is immediately clear where the treated area begins, as far less of the colorant sticks to the screen.

The screen is then allowed to air dry for 45 minutes and then rinsed with water. The area of a screen that is treated with DPC-8905 rinses clean on both sides after only seconds of rinsing while the untreated area remains deeply stained. Microscopic examination reveals considerable partial or complete blockage of the untreated area and virtually none on the area of the screen that is treated with DPC-8905.

In further experiments, cylindrical nickel print screens treated with DPC-8905 and subjected to a heat treatment as described above were installed on a textile printing machine. Acceptable printing quality was maintained for a substantially longer time with a cylindrical print screen treated with DPC-8905 versus untreated screens, and the treated screen was easily cleaned after this time period. Even when the printing machine was shut down for several hours, the treated screen was easily cleaned.

Certain embodiments of this invention have been described above, but the invention is not limited thereto. It should be understood that numerous changes to the described embodiments can be made in accordance with the disclosure herein without departing from the spirit or scope of the invention. The examples are therefore not meant to limit the scope of the invention. Rather, the scope of the invention is to be determined only by the appended claims and their equivalents.

What is claimed is:

1. A method of treating a print screen, which comprises treating the print screen with a compound containing a fluorinated radical and a polar inorganic or organic radical.

2. A method according to claim 1, which comprises treating the print screen with a compound of the formula
((R_{F})ₓ-W)ₙZ (1)
wherein
R_{F} is a straight or branched-chain perfluoroalkyl group containing 4 to 20 carbon atoms,
W is an aliphatic or cycloaliphatic radical with 1 to 15 carbon atoms,
x is 1-3,
n is 1 or 2, depending on the valence of Z, and
Z is a polar inorganic or organic radical.

3. A method according to claim 1, wherein the polar radical is acidic.

4. A method according to claim 1, wherein the polar radical is selected from the group consisting of —COOH, —SO₃H, —PO₂H, —P(OH)₂ and —OP(O)(OH)₂ wherein n is 1 and O₂P(O)OH wherein n is 2, and salts thereof.

5. A method according to claim 4, wherein the polar radical is —OP(O)(OH)₂ when n is 1 and O₂P(O)OH when n is 2, or a mixture thereof.

6. A method according to claim 1, wherein the polar radical is an acidic radical or a mixture of acidic radicals and is partially or fully in the form of an ammonium salt, or an ammonium salt that is mono-, di-, tri- or tetra-substituted by C₁-C₄alkyl, C₁-C₄-hydroxyalkyl or a mixture thereof.

7. A method according to claim 6, wherein the acidic polar radical or mixture of radicals is in the form of a diethanol-, disopropanol- or triethanolammonium salt.

8. A method according to claim 2, which comprises treating the print screen with a compound of the formula (1)
wherein
R_{F} is a straight or branched-chain perfluoroalkyl group containing 6 to 16 carbon atoms,
W is an aliphatic or cycloaliphatic radical with 1 to 12 carbon atoms,
x is 1-2,
n is 1 or 2, depending on the valence of Z, and
Z is a mixture of —OP(O)(OH)₂ and O₂P(O)OH radicals or salts thereof.

9. A method according to claim 8, wherein Z is partially or fully in the form of the diethanolammonium salts of the —OP(O)(OH)₂ and O₂P(O)OH radicals.

10. A method according to claim 9, wherein x is 1 and W is —CH₂—CH₂—.

11. A method according to claim 1, which comprises treating the print screen with a composition comprising 0.1-35% by weight of a compound containing a fluorinated radical and a polar inorganic or organic radical.

12. A method according to claim 11, which comprises treating the print screen with a composition comprising 0.1-35% by weight of a fluorine-containing compound of the formula
((R_{F})ₓ-W)ₙZ (1)
wherein
R_{F} is a straight or branched-chain perfluoroalkyl group containing 4 to 20 carbon atoms,
W is an aliphatic or cycloaliphatic with 1 to 15 carbon atoms,
x is 1-3,
n is 1 or 2, depending on the valence of Z, and
Z is a polar inorganic or organic radical.

13. A method according to claim 12, which comprises treating the print screen with a composition comprising 2-6% by weight of a fluorine-containing compound of the formula
((R_{F})ₓ-W)ₙZ (1)
wherein
R_{F} is a straight or branched-chain perfluoroalkyl group containing 6 to 16 carbon atoms,
W is alkylene with 1 to 12 carbon atoms,
x is 1 or 2,
n is 1 or 2, depending on the valence of Z, and
Z is a mixture of —OP(O)(OH)₂ and O₂P(O)OH radicals which are partially or fully in the form of their diethanolammonium salts.

14. A method according to claim 1, wherein the treated screen is subjected to a heat treatment.

15. A method according to claim 14, wherein the heat treatment is carried out at a temperature of from 80-230° C.

16. A print screen or print roller made of metal and/or synthetic organic material which has been treated with a fluorine-containing compound containing a fluorinated radical and a polar radical as described in claim 1.

17. A method of printing textile material or paper wherein a print screen or print roller according to claim 16 is used.
